(19) United States
(12) Patent Application Publication
(10) Pub. No.: US 2010/0208033 A1
(43) Pub. Date: Aug. 19, 2010

(54) Personal Media Landscapes in Mixed Reality

(75) Inventors: Darren K. Edge, Beijing (CN); Eric Chang, Beijing (CN); Kyungmin Min, Beijing (CN)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/371,431

(22) Filed: Feb. 13, 2009

(51) Int. Cl. H04N 13/02; G06T 15/00; G06F 3/048

(52) U.S. Cl. 348/46; 345/419; 715/850; 348/E13.074

(57) ABSTRACT

An exemplary method includes accessing geometrically located data that represent one or more virtual items with respect to a three-dimensional coordinate system; generating a three-dimensional map based at least in part on real image data of a three-dimensional space as acquired by a camera; rendering to a physical display a mixed reality scene that includes the one or more virtual items at respective three-dimensional positions in a real image of the three-dimensional space acquired by the camera; and re-rendering to the physical display the mixed reality scene upon a change in the field of view of the camera. Other methods, devices, systems, etc., are also disclosed.

### BACKGROUND

Over time, people transform areas surrounding their desktop computers into rich landscapes of information and interaction cues. While some may refer to such items as clutter, to any particular person, the items are often invaluable and enhance productivity. Of the variety of at-hand physical media, perhaps, none are as flexible and ubiquitous as a sticky note. Sticky notes can be placed on nearly any surface, as prominent or as peripheral as desired, and can be created, posted, updated, and relocated according to the flow of one's activities.

When a person engages in mobile computing, however, she loses the benefit of an inhabited interaction context. Hence, the sticky notes created at her kitchen table may be cleaned away and, during their time at the kitchen table, they are not visible from the living room sofa. Moreover, a person's willingness to share his notes with family and colleagues typically does not extend to the passing people in public places such as coffee shops and libraries. A similar problem is experienced by the users of shared computers: the absence of a physically-customizable, personal information space.

Physical sticky notes have a number of characteristics that help support user activities. They are persistent—situated in a particular physical place—making them both at-hand and glanceable. Their physical immediacy and separation from computer-based interactions make the use of physical sticky notes preferable when information needs to be recorded quickly, on the periphery of a user's workspace and attention, for future reference and reminding.

With respect to computer-based “sticky” notes, a web application provides for creating and placing so-called “sticky” notes on a screen where typed contents are stored, and restored when the “sticky” note application is restarted. This particular approach merely places typed notes in a two-dimensional flat space. As such, they are not so at-hand as physical notes; nor are they as glanceable (e.g., once the user's desktop becomes a “workspace” filled with layers of open applications interfaces, the user must intentionally switch to the sticky note application in order to refer to her notes). For the foregoing reasons, the “sticky” note approach can be seen as a more private form of sticky note, only visible at a user's discretion.

As described herein, various exemplary methods, devices, systems, etc., allow for creation of media landscapes in mixed reality that provide a user with a wide variety of options and functionality.

### SUMMARY

An exemplary method includes accessing geometrically located data that represent one or more virtual items with respect to a three-dimensional coordinate system; generating a three-dimensional map based at least in part on real image data of a three-dimensional space as acquired by a camera; rendering to a physical display a mixed reality scene that includes the one or more virtual items at respective three-dimensional positions in a real image of the three-dimensional space acquired by the camera; and re-rendering to the physical display the mixed reality scene upon a change in the field of view of the camera. Other methods, devices, systems, etc., are also disclosed.

### DESCRIPTION OF DRAWINGS

Non-limiting and non-exhaustive examples are described with reference to the following figures:

FIG. 1 is a diagram of a reality space and a mixed reality space along with various systems that provide for creation of mixed reality spaces;

FIG. 2 is a diagram of various equipment in a reality space and mixed reality spaces created through use of such equipment;

FIG. 3 is a block diagram of an exemplary method for mapping an environment, tracking camera motion and rendering a mixed reality scene;

FIG. 4 is a state diagram of various states and actions that provide for movement between states in a system configured to render a mixed reality scene;

FIG. 5 is a block diagram of an exemplary method for rendering a mixed reality scene;

FIG. 6 is a block diagram of an exemplary method for retrieving content from a remote site and rendering the content in a mixed reality scene;

FIG. 7 is a diagram of a mixed reality scene and a block diagram of an exemplary method for rendering and aging items;

FIG. 8 is a block diagram of various exemplary modules that include executable instructions related to generation of mixed reality scenes; and

FIG. 9 is a block diagram of an exemplary computing device.

### DETAILED DESCRIPTION

### Overview

An exemplary application relies on camera images to build a map of a physical environment while essentially simultaneously calculating the camera's position relative to the map. Virtual items are treated as graphics to be positioned with respect to the map and rendered as graphics in conjunction with real camera images to provide a mixed reality scene.

Various examples described herein demonstrate techniques that allow a person to access the same media and information in a variety of locations and across a wide range of devices from PCs to mobile phones and from projected to head-mounted displays. Such techniques can provide users with a consistent and convenient way of interacting with information and media of special importance to them (reminders, social and news feeds, bookmarks, etc.). As explained, an exemplary system allows a user to smoothly switch away from her focal activity (e.g. watching a film, writing a document, browsing the web), to interact periodically with any of a variety of things of special importance.

In various examples, techniques are shown that provide a user various ways to engage with different kinds of digital information or media (e.g., displayed as “sticky note”-like icons that appear to float in the 3D space around the user). Such items can be made visible through an “augmented reality” (AR) where real-time video of the real world is modified by various exemplary techniques before being displayed to the user.

In a particular example, a personal media landscape of augmented reality sticky notes is referred to as a “NoteScape”. In this example, a user can establish an origin of her NoteScape by pointing her camera in a direction of interest (e.g. towards her computer display) and triggering the construction of a map of her local environment (e.g. by pressing the spacebar). As the user moves her camera through space, the system extends its map of the environment and inserts images of previously created notes. Whenever the user accesses her NoteScape, wherever she is, she can see the same notes in the same relative location to the origin of the established NoteScape in her local environment.

Various methods provide for a physical style of interaction that is both convenient and consistent across different devices, supporting periodic interactions (e.g. every 5-15 minutes) with one or more augmented reality items that may represent things of special or ongoing importance to the user (e.g. social network activity).

As explained herein, an exemplary system can bridge the gap between regular computer use and augmented reality, in a way that supports seamless transitions and information flow between the two. Whether using a PC, laptop, mobile phone, or head-mounted device, it is the display of applications (e.g. word processor, media player, web browser) in a “virtual” device displayed 2D workspace (e.g. the WINDOWS® desktop) that typically forms the focus of a user's attention. In a particular implementation using a laptop computer and a webcam, motion of the webcam (directly or indirectly) switches the laptop computer display between a 2D workspace and a 3D augmented reality. In other words, when the webcam was stationary, the laptop function returned to normal, but when the user picked up the webcam, his laptop display transformed into a view of augmented reality, as seen, at least in part, through the webcam.

A particular feature in the foregoing implementation allowed whatever the user was last viewing on the actual 2D workspace to remain on the laptop display when the user switched to the augmented reality. This approach allowed for use of the webcam to drag and drop virtual content from the 2D workspace into the 3D augmented reality around the laptop, and also to select between many notes in the augmented reality NoteScape to open in the workspace. For example, consider a user browsing the web on her laptop at home. When this user comes across a webpage she would like to have more convenient access to in future, she can pick up her webcam and points it at her laptop. In the augmented reality she can see through the webcam image that her laptop is still showing the same webpage, however, she can also see many virtual items (e.g., sticky-note icons) “floating” in the space around her laptop. Upon pointing crosshairs of the webcam at the browser tab (e.g., while holding down the spacebar of her laptop), she can “grab” the browser tab as a new item and drag it outside of the laptop screen. In turn, she can position the item, for example, high up to the left of her laptop, nearby other related bookmarks. The user can then set down the webcam and continue browsing. Then, a few days later, when she wants to access that webpage again, she can pick up the webcam, point it at the note that links to that webpage (e.g., which is still in the same place high up and to the left of her laptop) and enter a command (e.g., press the spacebar). Upon entry of the command, the augmented reality scene disappears and the webpage is opened in a new tab inside her web browser in the 2D display of her laptop.

Another aspect of various techniques described herein pertains to portability of virtual items (e.g., items in a personal “NoteScapes”) that a user can access wherever he is located (e.g., with any combination of appropriate device plus camera). For example, a user may rely on a PC or laptop with webcam (or mobile camera phone acting as a webcam), an ultra-mobile PC with consumer head-mounted display (e.g. WRAP 920AV video eyewear device, marketed by Vuzix Corporation, Rochester, N.Y.), or a sophisticated mobile camera phone device with appropriate on-board resources. As explained, depending on particular settings or preferences, style of interaction may be made consistent across various devices as a user's virtual items are rendered and displayed in the same spatial relationship to her focus (e.g. a laptop display), essentially in disregard to the user's actual physical environment. For example, consider a user sitting at her desk PC using a webcam like a flashlight to scan the space around her, with the video feed from the webcam shown on her PC monitor. If she posts a note in a particular position (e.g. eye-level, at arm's length 45 degrees to their right), the note can be represented as geometrically located data such that it always appears in the same relative position when she access her virtual items. So, in this example, if the user is later sitting on her sofa and wants to access the note again, pointing her mobile camera phone towards the same position as before (e.g. eye-level, at arm's length 45 degrees to their right) would let her view the same note, but this time on the display of her mobile phone. In the absence of a physical device to point at (such as with a mobile camera phone, in which the display is fixed behind the camera), a switch to augmented reality may be triggered by some action other than camera motion (e.g. a touch gesture on the screen). In an augmented reality mode, the last displayed workspace may then be projected at a distance in front of the camera, acting as “virtual” display from which the user can drag and drop content into her mixed reality scene (e.g., personal “NoteScape”).

Various exemplary techniques described herein allow a user to build up a rich collection of “peripheral” information and media that can help her to live, work, and play wherever she is, using the workspace of any computing device with camera and display capabilities. For example, upon command, an exemplary application executing on a computing device can transition from a configuration that uses a mouse to indirectly browse and organize icons on a 2D display to a configuration that uses a camera to directly scan and arrange items in a 3D space; where the latter can aim to give the user the sense that the things of special importance to her are always within reach.

Various examples can address static arrangement of such things as text notes, file and application shortcuts, and web bookmarks, but also the dynamic projection of media collections (e.g. photos, album covers) onto real 3D space, and the dynamic creation and rearrangement of notes according to the evolution of news feeds from social networks, news sites, collaborative file spaces, and more. At work, notifications from email and elsewhere may be presented spatially (e.g., always a flick of a webcam away). At home, alternative TV channels may play in virtual screens around a real TV screen where the virtual screens may be browsed and selected using a device such as a mobile phone.

In various implementations, there is no need for special physical markers (e.g., a fiducial marker or markers, a standard geometrical structure or feature, etc.). In such an implementation, a user with a computing device, a display, and a camera can generate a map and a mixed reality scene where rather than positioning “augmentations” relative to physical markers, items are positioned relative to a focus of the user. At a dedicated workspace such as a table, this focus might be the user's laptop PC. In a mobile scenario, however, the focus might be the direction in which the user is facing. Various implementations can accurately position notes in a 3D space without using any special printed markers through use of certain computer vision techniques that allow for building a map of a local environment, for example, as a user moves the camera around. In such a manner, the same augmentations can be displayed whatever the map happens to be—as the map is used to provide a frame of reference for stable positioning of the augmentations relative to the user. Accordingly, such an approach provides a user with consistent and convenient access to items (e.g., digital media, information, applications, etc.) that are of special importance through use of nearly any combination of display and camera, in any location.

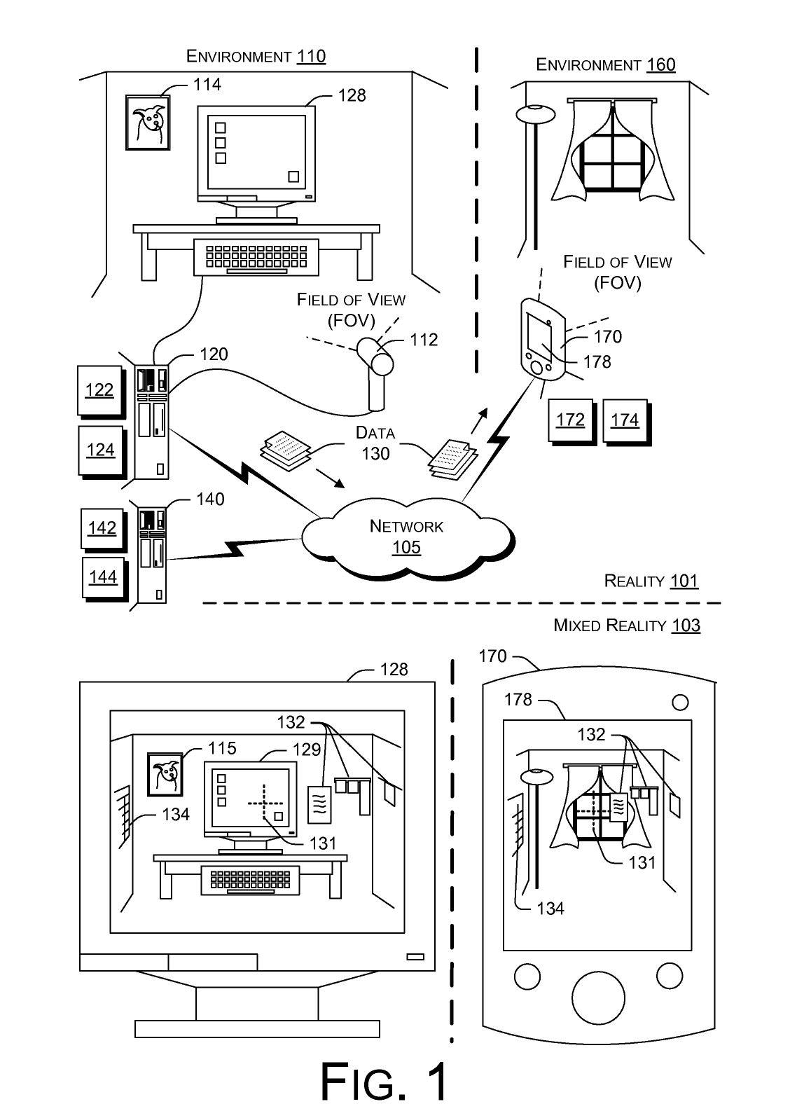

FIG. 1 shows a reality space 101 and a mixed reality space 103 along with a first environment 110 and a second environment 160. The environment 110 may be considered a local or base environment and the environment 160 may be considered a remote environment in the example of FIG. 1. In the base environment 110, a device 112 that includes a CCD or other type of sensor to convert received radiation into signals or data representative of objects such as the wall art 114 and a monitor 128. For example, the device 112 may be a video camera (e.g., a webcam). Other types of sensors may be sonar, infrared, etc. In general, the device 112 allows for real time acquisition of information sufficient to allow for generation of a map of a physical space, typically a three-dimensional physical space.

As shown in FIG. 1, a computer 120 with a processing unit 122 and memory 124 receives information from the device 112. The computer 120 includes a mapping module stored in memory 124 and executable by the processing unit 122 to generate a map based on the received information. Given the map, a user of the computer 120 can locate data geometrically and store the geometrically located data in memory 124 of the computer 120 or transmit the geometrically located data 130, for example, via a network 105.

As described herein, geometrically located data is data that has been assigned a location in a space defined by a map. Such data may be text data, image data, link data (e.g., URL or other), video data, audio data, etc. As described herein, geometrically located data (which may simply specify an icon or marker in space) may be rendered on a display device in a location based on a map. Importantly, the map need not be the same map that was originally used to locate the data. For example, the text “Hello World!” may be located at coordinates x₁, y₁, z₁ using a map of a first environment. The text “Hello World!” may then be stored with the coordinates x₁, y₁, z₁ (i.e., to be geometrically located data). In turn, a new map may be generated in the first environment or in a different environment and the text displayed on a monitor according to the coordinates x₁, y₁, z₁ of the geometrically located data.

To more clearly explain geometrically located data, consider the mixed reality space 103 and the items 132 and 134 rendered in the view on the monitor 128. These items may or may not exist in the “real” environment 110, however, they do exist as geometrically located data 130. Specifically, the items 132 are shown as documents such as “sticky notes” or posted memos while the item 134 is shown as a calendar. As described herein, a user associates data with a location and then causes the geometrically located data to be stored for future use. In various examples, so-called “future use” is triggered by a device such as the device 112. For example, as the device 112 captures information from a field of view (FOV), the computer 120 renders the FOV on the monitor 128 along with the geometrically located data 132 and 134. Hence, in FIG. 1, the monitor 128 in the mixed reality space 103 displays the “real” environment 110 along with “virtual” objects 132 and 134 as dictated by the geometrically located data 130. To assist with FOV navigation and item selection, a reticule or crosshairs 131 are also shown.

In the example of FIG. 1, the geometrically located data 130 is portable in that it can be rendered with respect to the remote environment 160, which differs from the base environment 110. In the environment 160, a user operates a handheld computing device 170 (e.g., a cell phone, wireless network device, etc.) that has a built-in video camera along with a processing unit 172, memory 174 and a display 178. In FIG. 1, a mapping module stored in the memory 174 and executable by the processing unit 172 of the handheld device 170 generates a map based on information acquired from the built-in video camera. The device 170 may receive the geometrically located data 130 via the network 105 (or other means) and then render the “real” environment 160 along with the “virtual” objects 132 and 134 as dictated by the geometrically located data 130.

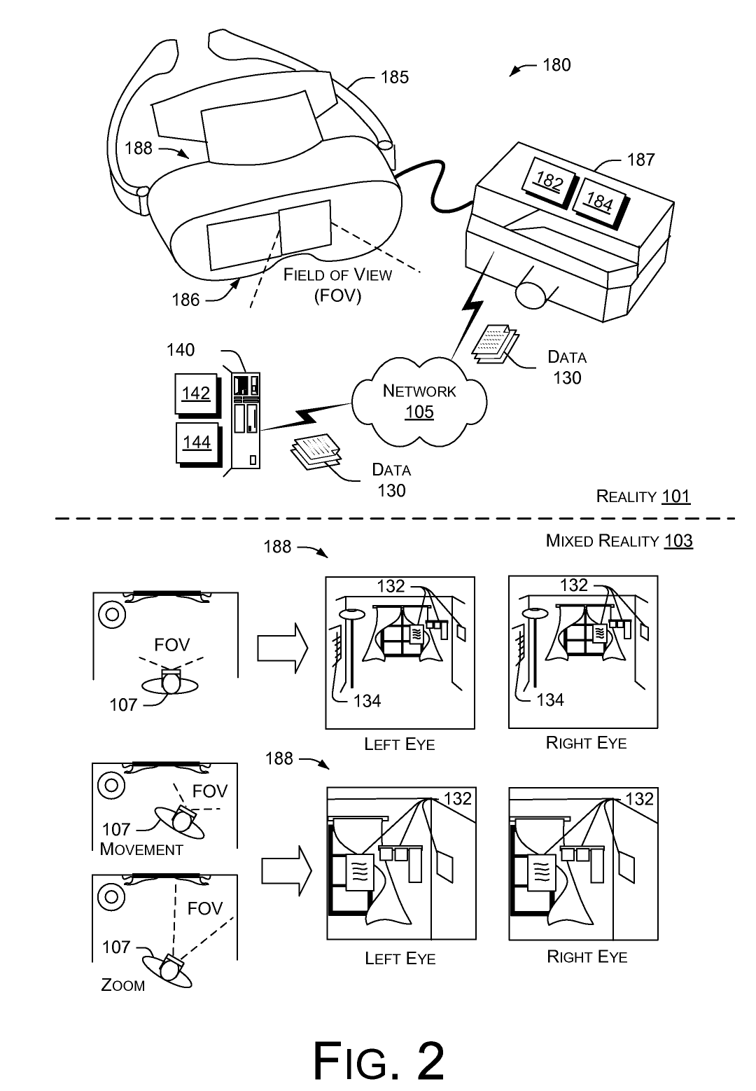

In another example, is shown in FIG. 2, with reference to various items in FIG. 1. In the example of FIG. 2, a user wears goggles 185 that include a video camera 186 and one or more displays 188. The goggles 185 may be self-contained in as head-wearable unit or may have an auxiliary component 187 for electronics and control (e.g., processing unit 182 and memory 184). The component 187 may be configured to receive geometrically located data 130 from another device (e.g., computing device 140) via a network 105. The component 187 may also be configured to geometrically locate data, as described further below. In general, the arrangement of FIG. 2, can operate similar to the device 170 of FIG. 1, except that the device would not be “handheld” but rather worn by the user.

An example of commercially available goggles is the Joint Optical Reflective Display (JORDY) goggles, which is based on the Low Vision Enhancement System (LVES), a video headset developed through a joint research project between NASA's Stennis Space Center, Johns Hopkins University, and the U.S. Department of Veterans Affairs. Worn like a pair of goggles, LVES includes two eye-level cameras, one with an unmagnified wide-angle view and one with magnification capabilities. The system manipulates the camera images to compensate for a person's low vision limitations. The LVES was marketed by Visionics Corporation (Minnetonka, Minn.).

FIG. 2 also shows a user 107 with respect to a plan view of the environment 160. The display 188 of the goggles 185 can include a left eye display and a right eye display; noting that the goggles 185 may optionally include a stereoscopic video camera. The left eye and the right eye displays may include some parallax to provide the user with a stereoscopic or “3D” view.

As described herein, a mixed reality view adaptively changes with respect to field of view (FOV) and/or view point (e.g., perspective). For example, when the user 107 moves in the environment, the virtual objects 132, based on geometrically located data 130, are rendered with respect to a map and displayed to match the change in the view point. In another example, the user 107 rotates a few degrees and causes the video camera (or cameras) to zoom (i.e., to narrow the field of view). In this example, the virtual objects 132, based on geometrically located data, are rendered with respect to a map and displayed to match the change in the rotational direction of the user 107 (e.g., goggles 185) and to match the change in the field of view. As described herein, zoom actions may be manual (e.g. using a handheld control, voice command, etc.) or automatic, for example, based on a heuristic (e.g. if a user gazes at the same object for approximately 5 seconds, then steadily zoom in).

With respect to lenses, a video camera (e.g., webcam) may include any of a variety of lenses, which may be interchangeable or have one or more moving elements. Hence, a video camera may be fitted with a zoom lens as explained with respect to FIG. 2. In another example, a video camera may be fitted with a so-called “fisheye” lens that provide a very wide field of view, which, in turn, can allow for rendering of virtual objects, based on geometrically located data and with respect to a map, within the very wide field of view. Such an approach may allow a user to quickly assess where her virtual objects are in an environment.

As mentioned, various exemplary methods include generating a map from images and then rendering virtual objects with respect to the map. An approach to map generation from images was described in 2007 by Klein and Murray (“Parallel tracking and mapping for small AR workspaces”, ISMAR 2007, which is incorporated by reference herein). In this article, Klein and Murray specifically describe a technique that uses keyframes and that splits tracking and mapping into two separate tasks that are processed in parallel threads on a dual-core computer where one thread tracks erratic hand-held motion and the other thread produces a 3D map of point features from previously observed video frames. This approach produces detailed maps with thousands of landmarks which can be tracked at frame-rate. The approach of Klein and Murray is referred to herein as PTM, another approach, referred to as simultaneous localization and mapping (EKF-SLAM) is also described. Klein and Murray indicate that PTM is more accurate and robust and provides for faster tracking than EKF-SLAM. Use of the techniques described by Klein and Murray allow for tracking without a prior model of an environment.

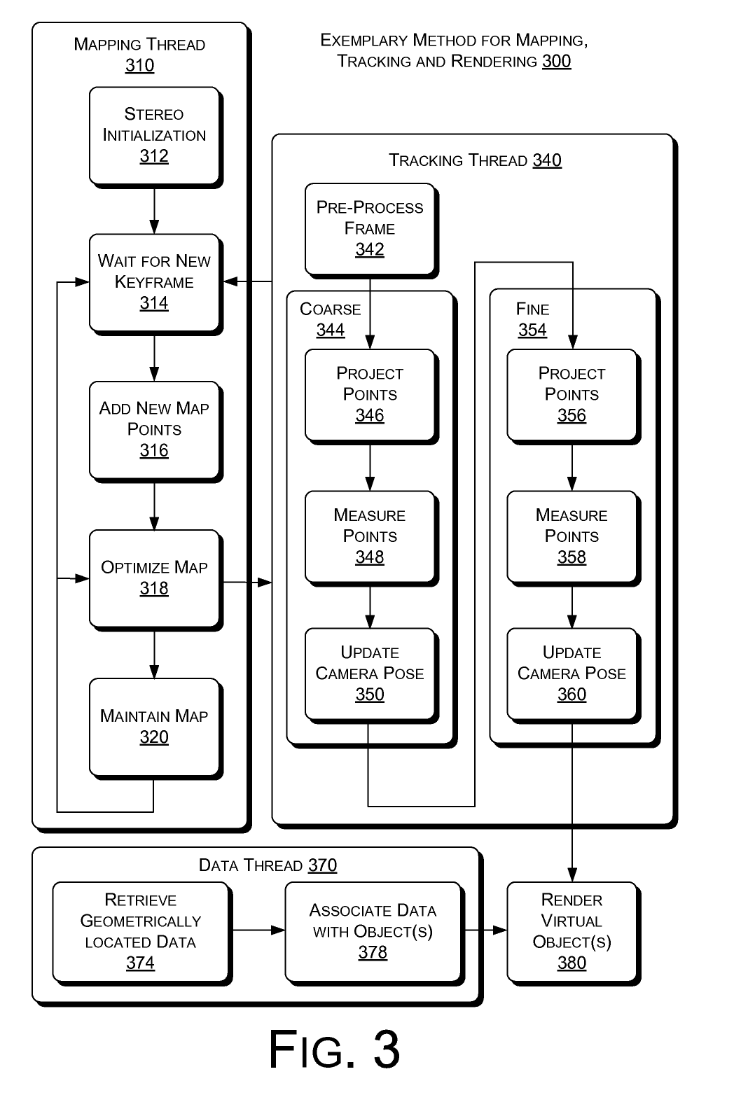

FIG. 3 shows an exemplary method for mapping, tracking and rendering 300. The method 300 includes a mapping thread 310, a tracking thread 340 and a so-called data thread 370 that allow for rendering of a virtual object 380 to thereby display a mixed reality scene. In general, the mapping thread 310 is configured to provide a map while the tracking thread 340 is configured to estimate camera pose. The mapping thread 310 and the tracking thread 340 may be the same or similar to the PTM approach of Klein and Murray. However, the method 300 need not necessarily execute on multiple cores. For example, the method 300 may execute on a single core processing unit.

The mapping thread 310 includes a stereo initialization block 312 that may use a five-point-pose algorithm. The stereo initialization block 312 relies on, for example, two frames and feature correspondences and provides an initial map. A user may cause two keyframes to be acquired for purposes of stereo initialization or two frames may be acquired automatically. Regarding the latter, such automatic acquisition may occur, at least in part, through use of fiducial markers or other known features in an environment. For example, in the environment 110 of FIG. 1, the monitor 128 may be recognized through pattern recognition and/or fiducial markers (e.g., placed at each of the four main corners of the monitor). Once recognized, the user may be instructed to change a camera's point of view while still including the known feature(s) to gain two perspectives of the known feature(s). Where information about an environment is not known a priori, a user may be required to cause the stereo initialization block 312 to acquire at least two frames. Where a camera is under automatic control, the camera may automatically alter a perspective (e.g., POV, FOV, etc.) to gain an additional perspective. Where a camera is a stereo camera, two frames may be acquired automatically, or an equivalent thereof.

The mapping thread 310 includes a wait block 314 that waits for a new keyframe. In a particular example, keyframes are added only if: there is a baseline to other keyframes and tracking quality is deemed acceptable. When a keyframe is added, an assurance is made such that (i) all points in the map are measured in the keyframe and that (ii) new map points are found and added to the map per an addition block 316. In general, the thread 310 performs more accurately as the number of points is increased. The addition block 316 performs a search in neighboring keyframes (e.g., epipolar search) and triangulates matches to add to the map.

As shown in FIG. 3, the mapping thread 310 includes an optimization block 318 to optimize a map. An optimization may adjusts map point positions and keyframe poses and minimize reprojection error of all points in all keyframes (or alternatively use only the last N keyframes). Such a map may have cubic complexity with keyframes and be linear with respect to map points. A map may be compatible with M-estimators.

A map maintenance block 320 acts to maintain a map, for example, where there is a lack of camera motion, the mapping thread 310 has idle time that may be used to improve the map. Hence, the block 320 may re-attempt outlier measurements, try to measure new map features in all old keyframes, etc.

The tracking thread 340 is shown as including a coarse pass 344 and a fine pass 354, where each pass includes a project points block 346, 356, a measure points block 348, 358 and an update camera pose block 350, 360. Prior to the coarse pass 344, a pre-process frame block 342 can create a monochromatic version and a polychromatic version of a frame and creates four “pyramid” levels of resolution (e.g., 640×480, 320×240, 160×120 and 80×60). The pre-process frame block 342 also performs pattern detection on the four levels of resolution (e.g., corner detection).

In the coarse pass 344, the point projection block 346 uses a motion model to update camera pose where all map points are projected to an image to determine which points are visible and at what pyramid level. The subset to measure may be about the 50 biggest features for the coarse pass 344 and about 1000 randomly selected features for the fine pass 356.

The point measurement blocks 348, 358 can be configured, for example, to generate an 8×8 matching template (e.g., warped from a source keyframe). The blocks 348, 358 can search a fixed radius around a projected position (e.g., using zero-mean SSD, searching only at FAST corner points) and perform, for example, up to about 10 inverse composition iterations for each subpixel position (e.g., for some patches) to find about 60% to about 70% of the patches.

The camera pose update block 350, 360 typically operates to solve a problem with six degrees of freedom. Depending on the circumstances (or requirements), a problem with fewer degrees of freedom may be solved.

With respect to the rendering block 380, the data thread 370 includes a retrieval block 374 to retrieve geometrically located data and an association block 378 that may associate geometrically located data with one or more objects. For example, the geometrically located data may specify a position for an object and when this information is passed to the render block 380, the object is rendered according to the geometry to generate a virtual object in a scene observed by a camera. As described herein, the method 300 is capable of operating in “real time”. For example, consider a frame rate of 24 fps, a frame is presented to a user about every 0.04 seconds (e.g., 40 ms). Most humans consider a frame rate of 24 fps acceptable to replicate real, smooth motion as would be observed naturally with one's own eyes.

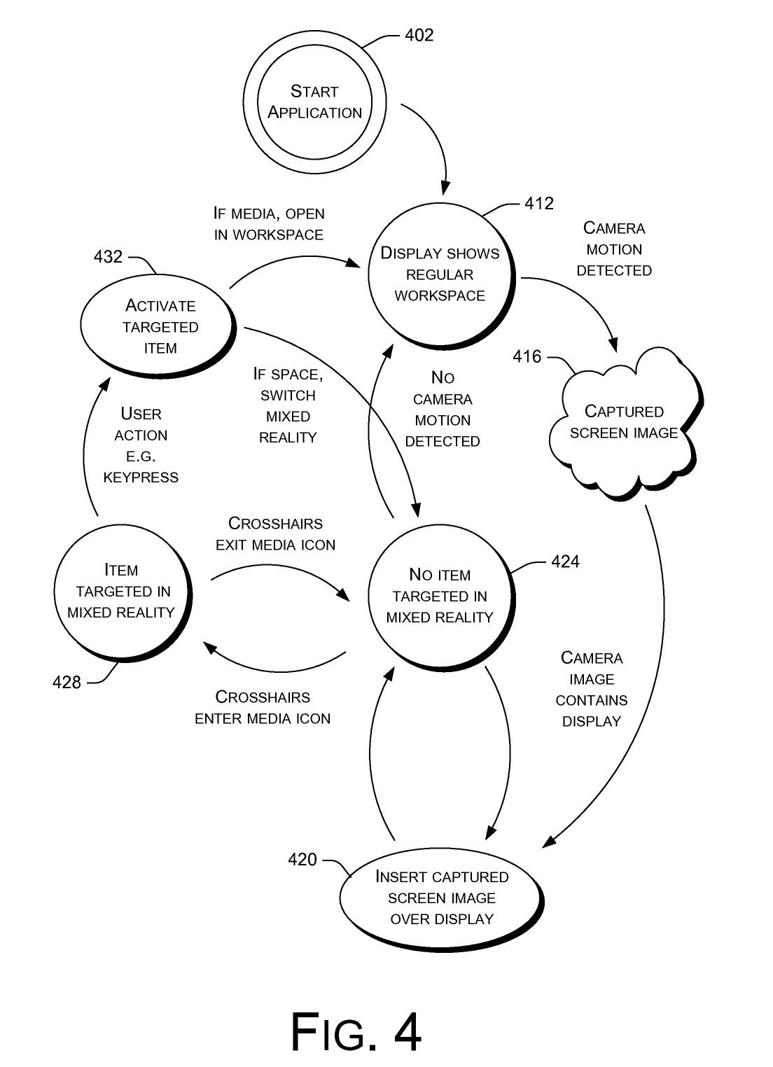

FIG. 4 shows a diagram of exemplary operational states 400 associated with generation of a mixed reality display. In a start state 402, a mixed reality application commences. In a commenced state 412, a display shows a regular workspace or desktop (e.g., regular icons, applications, etc.). In the state 412, if camera motion (e.g., panning, zooming or change in point of view) is detected, the application initiates a screen capture 416 of the workspace as displayed. The application can use the screen capture of the workspace to avoid an infinite loop between a camera image and the display that displays the camera image. For example, the application can display, on the display, the camera image of the environment around a physical display (e.g., computer monitor) along with the captured screen image (e.g., the user's workspace). Such a process allows a user to see what was on her display at the time camera motion was detected. In FIG. 4, a state 420 provides for such functionality (“insert captured screen image over display”) when the camera image contains the physical display.

FIG. 4 also shows various states 424, 428, and 432 related to items in a mixed reality scene. The state 424 pertains to no item being targeted in a mixed reality scene, the state 428 pertains to an item being targeted in a mixed reality scene and the state 432 pertains to activation of a targeted item in a mixed reality scene.

In the example of FIG. 4, the application moves between the states 424 and 428 based on crosshairs that can target a media icon, which may be considered an item or link to an item. For example, in FIG. 1, a user may pan a camera such that crosshairs line up with (i.e., target) the virtual item 134 in the mixed reality scene. In another example, a camera may be positioned on a stand and controlled by a sequence of voice commands such as “camera on”, “left”, “zoom” and “target” to thereby target the virtual item 134 in the mixed reality scene. Once an item has been targeted, a user may cause the application to activate the targeted item as indicated by the state 432. If the activation “opens” a media item, the application may return to the state 412 and display the regular workspace with the media item open or otherwise activated (e.g., consider a music file played using a media player that can play the music without necessarily requiring display of a user interface). The application may move from the state 432 to the state 424, for example, upon movement of a camera away from an icon or item. Further, where no camera motion is detected, the application may move from the state 424 to the state 412. Such a change in state may occur after expiration of a timer (e.g., no movement for 3 seconds, return to the state 412).

While the foregoing example mentions targeting via crosshairs, other techniques may include 3D “liquid browsing” that can, for example, be capable of causing separation of overlapping items within a particular FOV (e.g., peak behind, step aside, lift out of the way, etc.). Such an approach could be automatic, triggered by a camera gesture (e.g. a spiral motion), a command, etc. Other 3D pointing schemes could also be applied.

In the state diagram 400 of FIG. 4, movement between states 412 and 420 may occur numerous times during a session. For example, a user may commence a session by picking up a camera to thereby cause an application to establish or access a map of the user's environment and, in turn, render a mixed reality scene as in the state 420. As explained below, virtual items in a mixed reality scene may include messages received from one or more other users (e.g., consider check email, check social network, check news, etc.). After review of the virtual items, the user may set down the camera to thereby cause the application to move to the state 412.

As the user continues with her session, the virtual content normally persists with respect to the map. Such an approach allows for quick reloading of content when the user once again picks up the camera (e.g., “camera motion detected”). Depending on the specifics of how the map exists in the underlying application, a matching process may occur that acts to recognize one or more features in the camera's FOV. If one or more features are recognized, then the application may rely on the pre-existing map. However, if recognition fails, then the application may act to reinitialize a map. Where a user relies on a mobile device, the latter may occur automatically and be optionally triggered by information (e.g., roaming information, IP address, GPS information, etc.) that indicates the user is no longer in a known environment or an environment with a pre-existing map.

An exemplary application may include an initialization control (e.g., keyboard, mouse, other command) that causes the application to remap an environment. As explained herein, a user may be instructed as to pan, tilt, zoom, etc., a camera to acquire sufficient information for map generation. An application may present various options as to map resolution or other aspects of a map (e.g., coordinate system).

In various examples, an application can generate personal media landscapes in mixed reality to present both physical and virtual items such as sticky notes, calendars, photographs, timers, tools, etc.

A particular exemplary system for so-called sticky notes is referred to herein as a NoteScape system. The NoteScape system allows a user to create a mixed reality scene that is a digital landscape of “virtual” media or notes in a physical environment. Conventional physical sticky notes have a number of qualities that help users to manage their work in their daily lives. Primarily, they provided a persistent context of interaction. Which means that that new notes are always at hand, ready to be used, and old notes are spread throughout the environment providing a glanceable display of the information that is of special importance to the user.

In the NoteScape system, virtual sticky notes exist as digital data that include geometric location. Virtual sticky notes can be portable and assignable to a user or a group of users. For example, a manager may email or otherwise transmit a virtual sticky note to a group of users. Upon receipt and camera motion, the virtual sticky note may be displayed in a mixed reality scene of a user according to some predefined geometric location. In this example, an interactive sticky note may then allow the user to link to some media content (e.g., an audio file or video file from the manager). Privacy can be maintained as a user can have control over when and how a note becomes visible.

The NoteScape system allows a user to visualize notes in a persistent and portable manner, both at hand and interactive, and glanceable yet private. The NoteScape system allows for mixed reality scenes that reinterpret how a user can organize and engage with any kind of digital media in a physical space (e.g., physical environment). As for paper notes, the NoteScape system provides a similar kind of peripheral support for primary tasks performed in a workspace having a focal computer (e.g., monitor with workspace).

The NoteScape system can optionally be implemented using a commodity web cam and a flashlight style of interaction to bridge the physical and virtual worlds. In accordance with the flashlight metaphor, a user points the web cam like a flashlight and observes the result on his monitor. Having decided where to set the origin of his “NoteScape”, the user may simply press the space bar to initiate creation of a map of the environment. In turn, the underlying NoteScape system application may begin positioning previously stored sticky notes as appropriate (e.g., based on geometric location data associated with the sticky notes). Further, the user may introduce new notes along with specified locations.

As described herein, notes or other items may be associated with a user or group of users (e.g., rather than any particular computing device). Such notes or other items can be readily accessed and interactive (e.g., optionally linking to multiple media types) while being simple to create, position, and reposition.

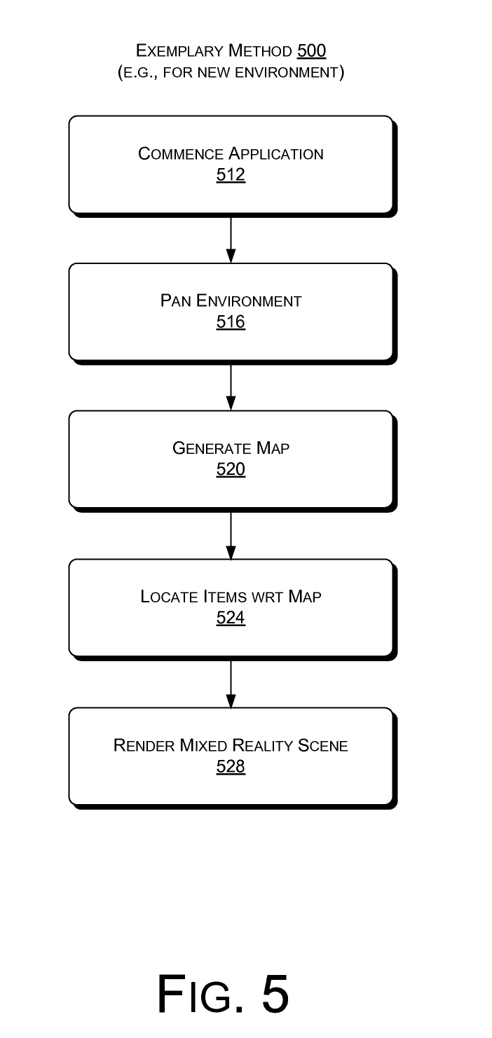

FIG. 5 shows an exemplary method 500 that may be implemented using a NoteScape system (e.g., a computing device, application modules and a camera). In a commencement block 512, an application commences that processes data sufficient to render a mixed reality scene. In the example of FIG. 5, the application relies on information acquired by a camera. Accordingly, in a pan environment block 516, a camera is used to acquire image information while panning an environment (e.g., to pan back and forth, left and right, up and down, etc.) and to provide the acquired image information, directly or indirectly, to a mapping module. For example, the acquired image information may be stored in a special memory buffer (e.g., of a graphics card) that is accessible by the mapping module. In a map generation block 520, the application relies on the mapping module to generate a map; noting that the mapping module may include instructions to perform the various mapping and tracking of FIG. 3.

Once a map of sufficient breadth and detail has been generated, in a location block 524, the application locates one or more virtual items with respect to the map. As mentioned, a virtual item typically includes content and geometrical location information. For example, a data file for a virtual sticky note may include size, color and text as well as coordinate information to geometrically locate the stick note with respect to a map. Characteristics such as size, color, text, etc., may be static or defined dynamically in the form of an animation. As discussed further below, such data may represent a complete interactive application fully operable in mixed reality. According to the method 500, a rendition block 528 renders a mixed reality scene to include one or more items geometrically positioned in a camera scene (e.g., a real video scene with rendered graphics). The rendition block 528 may rely on z-buffering (or other buffering techniques) for management of depth of virtual items and for POV (e.g., optionally including shadows, etc.). Transparency or other graphical image techniques may also be applied to one or more virtual items in a mixed reality scene (e.g., fade note to 100% transparency over 2 weeks). Accordingly, a virtual item may be a multi-dimensional graphic, rendered with respect to a map and optionally animated in any of a variety of manners. Further, the size of any particular virtual item is essentially without limit. For example, a very small item may be secretly placed and zoomed into (e.g., using macro lens) to reveal content or to activate.

As described herein, the exemplary method 500 may be applied in most any environment that lends itself to map generation. In other words, while initial locations of virtual items may be set in one environment, a user may represent these virtual items in essentially the locations in another environment (see, e.g., environments 110 and 160 of FIG. 1). Further, a user may edit a virtual item in one environment and later render the edited virtual item in another environment. Accordingly, a user may maintain a file or set of files that contain geometrically located data sufficient to render one or more virtual items in any of a variety of environments. In such a manner, a user's virtual space is portable and reproducible. In contrast, a sticky note posted in a user's office, is likely to stay in that office, which confounds travel away from the office where ease of access to information is important (e.g., how often does a traveling colleague call and ask: “Could you please look on my wall and get that number?”).

Depending on available computing resources or settings, a user may have an ability to extend an environment, for example, to build a bigger map. For example, at first a user may rely on a small FOV and few POVs (e.g., a one meter by one meter by one meter space). If this space becomes cluttered physically or virtually, a user may extend the environment, typically in width, for example, by sweeping a broader angle from a desk chair. In such an example, fuzziness may appear around the edges of an environment, indicating uncertainty in the map that has been created. As the user pans around their environment, the map is extended to incorporate these new areas and the uncertainty is reduced. Unlike conventional sticky notes, which adhere to physical surfaces, virtual items can be placed anywhere within a three-dimensional space.

As indicated in state diagram of FIG. 4, virtual items can be both glanceable and private through use of camera motion as an activating switch. In such an example, whenever motion is detected, an underlying application can automatically convert a monitor display to a temporary window of a mixed reality scene. Such action is quick and simple and its affects can be realized immediately. Moreover, timing is controllable by the user such that her “NoteScape” is only displayed at her discretion. As mentioned, another approach may rely on a camera that is not handheld and activated by voice commands, keystrokes, a mouse, etc. For example, a mouse may have a button programmed to activate a camera and mixed reality environment where movement of the mouse (or pushing of buttons, rolling of a scroll wheel, etc.) controls the camera (e.g., pan, tilt, zoom, etc.). Further, a mouse may control activation of a virtual item in a mixed reality scene.

As mentioned, virtual items may include any of a variety of content. For example, consider the wall art 114 in the environment 110 of FIG. 1, which is displayed as item 115 in the mixed reality scene 103 on the monitor 128. In a particular example, the item 115 may be a photo album where the item 115 is an icon that can be targeted and activated by a user to display and browse photos (e.g., family, friends, a favorite pet, etc.). Such photos may be stored locally on a computing device or remotely (e.g., accessed via a link to a storage site). Further, activation of the item 115 may cause a row or a grid of photos to appear, which can be individually selected and optionally zoomed-in or approached with a handheld camera for a closer look.

With respect to linked media content, a user may provide a link to a social networking site where a user or the user has loaded media files. For example, various social networking sites allow a user to load photos and to share the photos with other users (e.g., invited friends). Referring again to the mixed reality scene 103 of the monitor 128 of FIG. 1, one of the virtual items 132 may link to a photo album of a friend on a social networking site. In such a manner, a user can quickly navigate a friend's photo album merely by directing a camera in its surrounding environment. A user may likewise have access to a control that allows for commenting on a photo, sending a message to the friend, etc. (e.g., control via keyboard, voice, mouse, etc.).

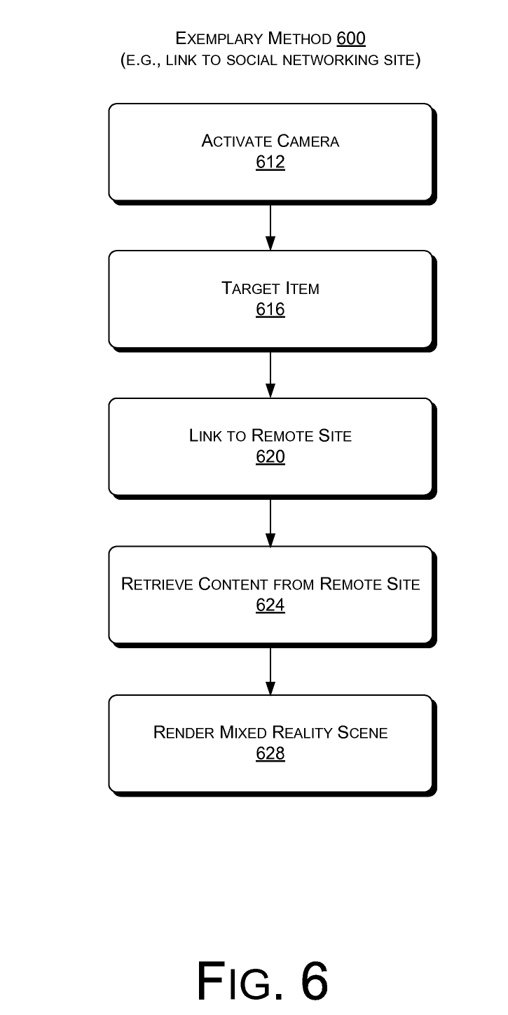

In another example, a virtual item may be a message “wall”, such a message wall associated with a social networking site that allows others to periodically post messages viewable to linked members of the user's social network. FIG. 6 shows an exemplary method 600 that may be implemented using a computing device that can access a remote site via a network. In an activation block 612, a user activates a camera. In a target block 616, the user targets a virtual item rendered in a mixed reality scene and within the camera's FOV. Upon activation of the item, a link block 620 establishes a link to a remote site. A retrieval block 624 retrieves content from the remote site (e.g., message wall, photos, etc.). Once retrieved, a rendition block 628 renders the content from the remote site in a mixed reality scene. Such a process may largely operate as a background process that retrieves the content on a regular basis. For example, consider a remote site that provides a news banner or advertisements such that the method 600 can readily present such content upon merely activating the camera. As mentioned, time may be used as a parameter in rendering virtual items. For example, virtual items that have some relationship to time or aging may fade, become smaller over time, etc.

An exemplary application may present one or more specialized icons for use in authoring content, for example, upon detection of camera motion. A specialized icon may be for text authoring where upon selection of the icon in a mixed reality scene, the display returns to a workspace with an open notepad window. A user may enter text in the notepad and then return to a display of the mixed reality scene to position the note. Once positioned, the text and the position are stored to memory (e.g., as geometrically located data, stored locally or remotely) to thereby allow for recreation of the note in a mixed reality scene for the same environment or a different environment. Such a process may automatically color code or date the note.

A user may have more than one set of geometrically located data. For example, a user may have a personal set of data, a work set of data, a social network set of data, etc. An application may allow a user to share a set of geometrically located data with one or more others (e.g., in a virtual clubhouse where position of virtual items relies on a local map of an actual physical environment). Users in a network may be capable of adding geometrically located data, editing geometrically located data, etc., in the context of a game, a spoof, a business purpose, etc. With respect to games and spoofs, a user may add or alter data to plant treats, toys, timers, send special emoticons, etc. An application may allow a user to respond to such virtual items (e.g., to delete, comment, etc.). An application may allow a user to finger or baton draw in a real physical environment where the finger or baton is tracked in a series of camera images to allow the finger or baton drawing to be extracted and then stored as being associated with a position in a mixed reality scene.

With respect to entertainment, virtual items may provide for playing multiple videos at different positions in a mixed reality scene, internet browsing at different positions in a mixed reality scene, or channel surfing of cable TV channels at different positions in a mixed reality scene.

As described herein, various types of content may be suitable for presentation in a mixed reality scene. For example, a gallery of media, of videos, of photos, and galleries of bookmarks of websites may be projected into a three dimensional space and rendered as a mixed reality scene. A user may organize any of a variety of files or file space for folders, applications, etc., in such a manner. Such techniques can effectively extend a desktop in three dimensions. As described herein, a virtual space can be decoupled from any particular physical place. Such an approach makes a mixed reality space shareable (e.g., two or more users can interact in the same conceptual space, while situated in different places), as well as switchable (the same physical space can support the display of multiple such mixed realities).

As described herein, various tasks may be performed in a cloud as in “cloud computing”. Cloud computing is an Internet based development in which typically real-time scalable resources are provided as a service. A mixed reality system may be implemented in part in a “software as a service” (SaaS) framework where resources accessible via the Internet act to satisfy various computational and/or storage needs. In a particular example, a user may access a website via a browser and rely on a camera to scan a local environment. In turn, the information acquired via the scan may be transmitted to a remote location for generation of a map. Geometrically located data may be accessed (e.g., from a local and/or a remote location) to allow for rendering a mixed reality scene. While part of the rendering necessarily occurs locally (e.g., screen buffer to display device), underlying virtual data or real data to populate a screen buffer may be generated or packaged remotely and transmitted to a user's local device.

In various trials, a local computing device performed parallel tracking and mapping as well as providing storage for geometrically located data sufficient to render graphics in a mixed reality scene. Particular trials operated with a frame rate of 15 fps on a monitor with a 1024×768 screen resolution using a web cam at 640×480 image capture resolution. A particular computing device relied on a single core processor with a speed of about 3 GHz and about 2 GB of RAM. Another trial relied on a portable computing device (e.g., laptop computer) with a dual core processor having a speed of about 2.5 GHz and about 512 MB of graphics memory, and operated with a frame rate of 15 fps on a monitor with a 1600×1050 screen resolution using a webcam at 800×600 image capture resolution

In the context of a webcam, camera images may be transmitted to a remote site for various processing in near real-time and geometrically located data may be stored at one or more remote sites. Such examples demonstrate how a system may operate to render a mixed reality scene. Depending on capabilities, parameters such as resolution, frame rate, FOV, etc., may be adjusted to provide a user with suitable performance (e.g., minimal delay, sufficient map accuracy, minimal shakiness, minimal tracking errors, etc.).

Given sufficient processing and memory, an exemplary application may render a mixed reality scene while executing on a desktop PC, a notebook PC, an ultra mobile PC, or a mobile phone. With respect to a mobile phone, many mobile phones are already equipped with a camera. Such an approach can assist a fully mobile user.

As described herein, virtual items represented by geometrically located data can be persistent and portable for display in a mixed reality scene. From a user's perspective, the items (e.g., notes or other items) are “always there”, even if not always visible. Given suitable security, the items cannot readily be moved or damaged. Moreover, the items can be made available to a user wherever the user has an appropriate camera, display device, and, in a cloud context, authenticated connection to an associated cloud-based service. In an offline context, standard version control techniques may be applied based on a most recent dataset (e.g., a most recently downloaded dataset).

As described herein, an application that renders a mixed reality scene provides a user with glanceable and private content. For example, a user can “glance at his notes” by simply picking up a camera and pointing it. Since the user can decide when, where, and how to do this, the user can keep content “private” if necessary.

As described herein, an exemplary system may operate according to a flashlight metaphor where a view from a camera is shown full-screen on a user's display where, at the center of the display is a targeting mark (e.g. crosshair or reticule). A user's actions (e.g. pressing a keyboard key, moving the camera) can have different effects depending on the position of the targeting mark relative to virtual items (e.g., virtual media). A user may activate corresponding item by any of a variety of commands (e.g., a keypress). Upon activation, an item that is a text-based note might open on-screen for editing, an item that is a music file might play in the background, an item that is a bookmark might open a new web-browser tab, a friend icon (composed of e.g. name, photo and status) might open that person's profile in a social network, and so on.

As described with respect to FIG. 4, when camera motion is detected, an application may instruct a computing device to perform a screen capture (e.g., of a photo or workspace). In this example, when the image of the screen appears in the camera feed displayed on the actual device screen, the user sees the previous screen contents (e.g. the photo or the workspace) in the image of the screen, and not the live camera feed. Such an approach eliminates the camera/display feedback loop and allows the user to interact in mixed reality without losing his workspace interaction context. Moreover, such an approach can allow a user to position the screen captured content (e.g. a photo) in a space (e.g., as a new “note” positioned in three dimensions).

When the camera is embedded within the computing device (such as with a mobile camera phone, camera-enabled Ultra-Mobile PC, or a “see through” head mounted display), camera motion alone cannot be used to enter the personal media landscape. In such situations, a different user action (e.g. touching or stroking the device screen) may trigger the transition to mixed reality. In such an implementation, an application may still insert a representation of the display at the origin (or other suitable location) of the established mixed reality scene to facilitate, for example, drag-and-drop interaction between the user's workspace and the mixed reality scene.

As explained, an exemplary application relies on camera images to build a map of a physical environment while essentially simultaneously calculating the camera's position relative to the map. Virtual items are typically treated as graphics to be positioned with respect to the map and rendered as graphics in conjunction with real camera images to provide a mixed reality scene.

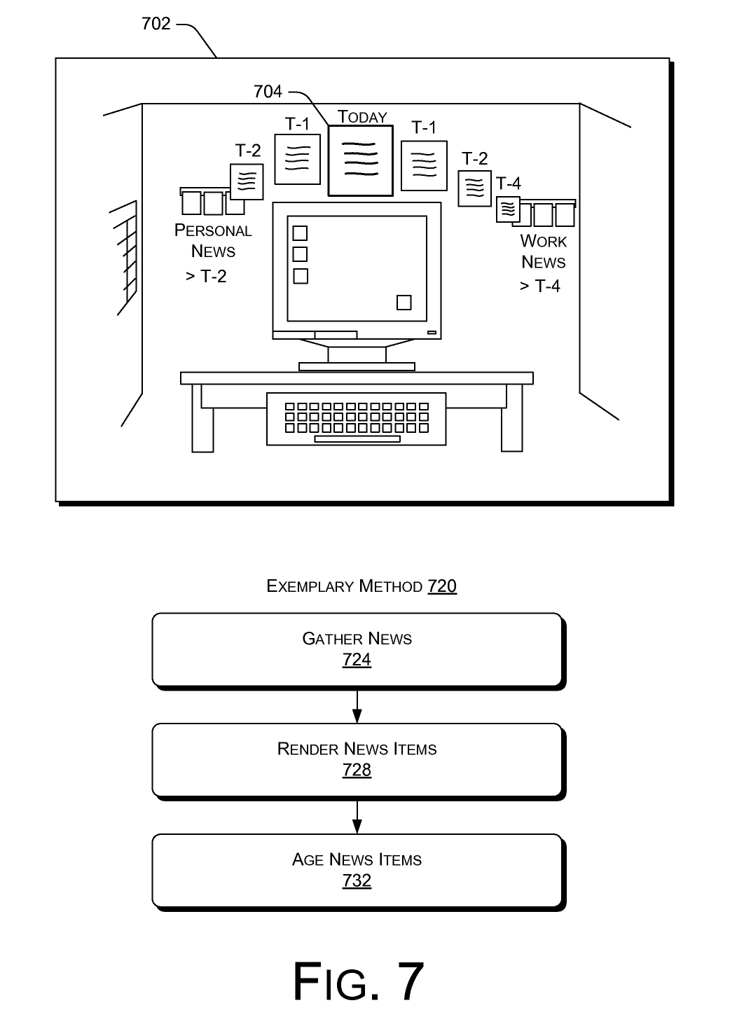

FIG. 7 shows an exemplary mixed reality scene 702 and an associated method 720 for aging items. As mentioned, items in a mixed reality scene may be manipulated to alter size, color, transparency, or other characteristics, for example, with respect to time. The mixed reality scene 702 displays how items may appear with respect to aging. For example, an item 704 that is fresh in time (e.g., received “today”) may be rendered in a particular geometric location. As time passes, the geometric location and/or other characteristics of an item may change. Specifically, in the example of FIG. 7, news items become smaller and migrate toward predefined news category stacks geometrically located in an environment. A “work news” stack receives items that are, for example, greater than four days old while a “personal news” stack receives items that are, for example, greater than two days old.

As indicated in FIG. 7, stacks may be further subdivided (e.g., work news from boss, work news from HR department, etc. and personal news from mom, personal news from kids, personal news about bank account, etc.). As a rendered mixed reality scene affords privacy, a user may choose to render otherwise sensitive items (e.g., pay statements, bank accounts, passwords for logging into network accounts, etc.). Such an approach supplants the “secret folder”, the location of which is often forgotten (e.g., as it may be seldom accessed during the few private moments of a typical work day). Yet further, as a stack of items is virtual, it may be made quite deep, without occupying any excessive amount of space in a mixed reality scene. An executable module may provide for searches through one or more stacks as well (e.g., date, key word, etc.). A search command or other command may cause dynamic rearrangement of one or more items, whether in a stack or other virtual geometric arrangement.

In the example of FIG. 7, the exemplary method 720 includes a gathering block 724 that gathers news from one or more sources (e.g., as specified by a user, an employer, a social network, etc.). A rendering block 728 renders the news as geometrically located items in a mixed reality scene. According to time, or other variable(s), an aging block 732 ages the items, for example, by altering geometric location data or rendering data (e.g., color, size, transparency, etc.). While the example of FIG. 7 pertains to news items, other types of content may be subject to similar treatment (e.g., quote of the week, artwork of the month, etc.).

As described herein, an item rendered in a mixed reality scene may optionally be an application. For example, an item may be a calculator application that is fully functional in a mixed reality scene by entry of commands (e.g., voice, keyboard, mouse, finger, etc.). As another example, consider a card game such as solitaire. A user may select a solitaire item in a mixed reality scene that, in turn, displays a set of playing cards where the cards are manipulated by issuance of one or more commands. Other examples may include a browser application, a communication application, a media application, etc.

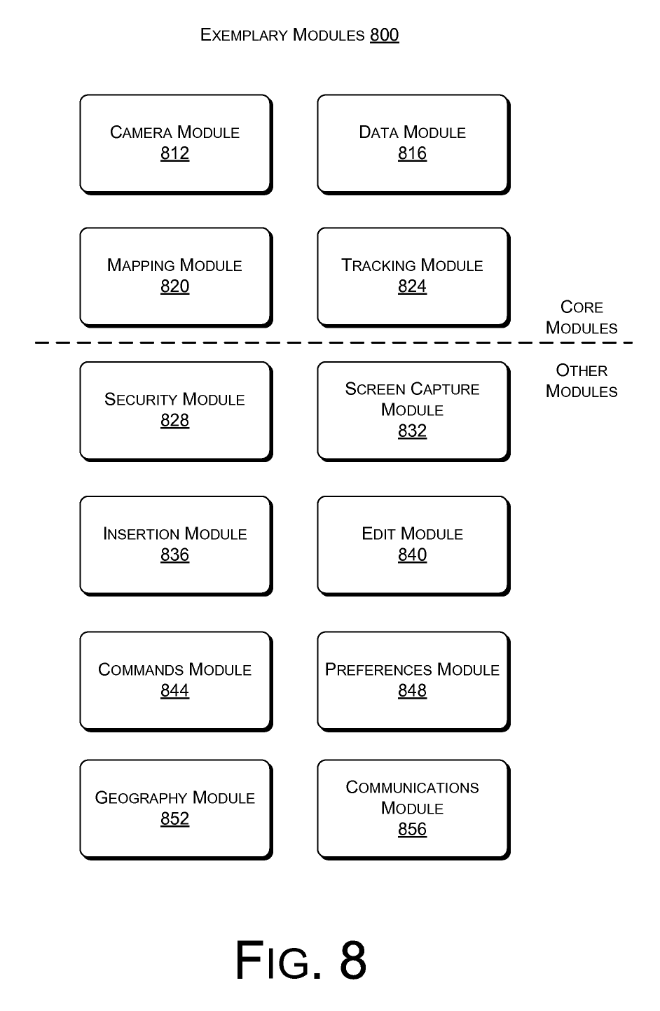

FIG. 8 shows various exemplary modules 800. An exemplary application may include some or all of the modules 800. In a basic configuration, an application may include four core modules: a camera module 812, a data module 816, a mapping module 820 and a tracking module 824. The core modules may include executable instructions to perform the method 300 of FIG. 3. For example, the mapping module 820 may include instructions for the mapping thread 310, the tracking module 824 may include instructions for the tracking thread 340 and the data module 816 may include instructions for the data thread 370. The rendering 380 of FIG. 3 may rely on a graphics processing unit (GPU) or other functional components to render a mixed reality scene. The core modules of FIG. 8 may issue commands to a GPU interface or other functional components for rendering. With respect to the camera module 812, this module may include instructions to access image data acquired via a camera and optionally provide for control of a camera, triggering certain action in response to camera movement, etc.

The other modules shown in FIG. 8 include a security module 828 that may provide security measures to protect a user's geometrically located data, for example, via a password or biometric security measure and a screen capture module 832 that acts to capture a screen for subsequent insertion into a mixed reality scene. The screen capture module can be configured to capture a displayed screen for subsequent rendering in a mixed reality scene to thereby avoid a feedback loop between a camera and a screen. With respect to geometrically located data, an insertion module 836 and an edit module 840 allow for inserting virtual items with respect to map geometry and for editing virtual items, whether editing includes action editing, content editing or geometric location editing. For example, the insertion module 836 may be configured to insert and geometrically locate one or more virtual items in a mixed reality scene while the edit module 840 may be configured to edit or relocate one or more virtual items in a mixed reality scene. While merely a link to an executable file for an application (e.g., an icon with a link to a file) may exist in the form of geometrically located data, such an application may be referred to as a geometrically located application.

FIG. 8 also shows a commands module 844, a preferences module 848, a geography module 852 and a communications module 856. The commands module 844 provides an interface to instruct an application. For example, the commands module 844 may provide for keyboard commands, voice commands, mouse commands, etc., to effectuate various actions germane to rendering a mixed reality scene. Commands may relate to camera motion, content creation, geometric position of virtual items, access to geometrically located data, transmission of geometrically located data, resolution, frame rate, color schemes, themes, communication, etc. The commands module 844 may be configured to receive commands from one or more input devices to thereby control operation of the application (e.g., a keyboard, a camera, a microphone, a mouse, a trackball, a touch screen, etc.).

The preferences module 848 allows a user to rely on default values or user selected or defined preferences. For example, a user may select frame rate and resolution for a desktop computer with superior video and graphics processing capabilities and select a different frame rate and resolution for a mobile computing device with lesser capabilities. Such preferences may be stored in conjunction with geometrically located data such that upon access of the data, an application operates with parameters to ensure acceptable performance. Again, such data may be stored on a portable memory device, memory of a computing device, memory associated with and accessible by a server, etc.

As mentioned, an application may rely on various modules, for example, including some or all of the modules 800 of FIG. 8. An exemplary application may include a mapping module configured to access real image data of a three-dimensional space as acquired by a camera and to generate a three-dimensional map based at least in part on the accessed real image data; a data module configured to access stored geometrically located data that represent one or more virtual items with respect to a three-dimensional coordinate system; and a rendering module configured to render graphically the one or more virtual items of the geometrically located data, with respect to the three-dimensional map, along with real image data acquired by the camera of the three-dimensional space to thereby provide for a displayable mixed reality scene. As explained, an application may further include a tracking module configured to track field of view of the camera in real-time to thereby provide for three-dimensional navigation of the displayable mixed reality scene.

In the foregoing application, the mapping module may be configured to access real image data of a three-dimensional space as acquired by a camera such as a webcam, a mobile phone camera, a head-mounted camera, etc. As mentioned, a camera may be a stereo camera.

As described herein, an exemplary system can include a camera with a changeable field of view; a display; and a computing device with at least one processor, memory, an input for the camera, an output for the display and control logic to generate a three-dimensional map based on real image data of a three-dimensional space acquired by the camera via the input, to locate one or more virtual items with respect to the three-dimensional map, to render a mixed reality scene to the display via the output where the mixed reality scene includes the one or more virtual items along with real image data of the three-dimensional space acquired by the camera and to re-render the mixed reality scene to the display via the output upon a change in the field of view of the camera. In such a system, the camera can have a field of view changeable, for example, by manual movement of the camera, by head movement of the camera or by zooming (e.g., an optical zoom and/or a digital zoom). Tracking or sensing techniques may be used as well, for example, by sensing movement by computing optical flow, by using one or more gyroscopes mounted on a camera, by using position sensors that compute the relative position of the camera (e.g., to determine the front of view of the camera), etc. Such techniques may be implemented by a tracking module of an exemplary application for generating mixed reality scenes.

Such a system may include control logic to store, as geometrically located data, data representing one or more virtual items located with respect to a three-dimensional coordinate system. As mentioned, a system may be a mobile computing device with a built in camera and a built in display.

As described herein, an exemplary method can be implemented at least in part by a computing device and include accessing geometrically located data that represent one or more virtual items with respect to a three-dimensional coordinate system; generating a three-dimensional map based at least in part on real image data of a three-dimensional space as acquired by a camera; rendering to a physical display a mixed reality scene that includes the one or more virtual items at respective three-dimensional positions in a real image of the three-dimensional space acquired by the camera; and re-rendering to the physical display the mixed reality scene upon a change in the field of view of the camera. Such a method may include issuing a command to target one of the one or more virtual items in the mixed reality scene and/or locating another virtual item in the mixed reality scene and storing data representing the virtual item with respect to a location in a three-dimensional coordinate system. As described herein, a module or method action may be in the form of one or more processor-readable media that include processor-executable instructions.

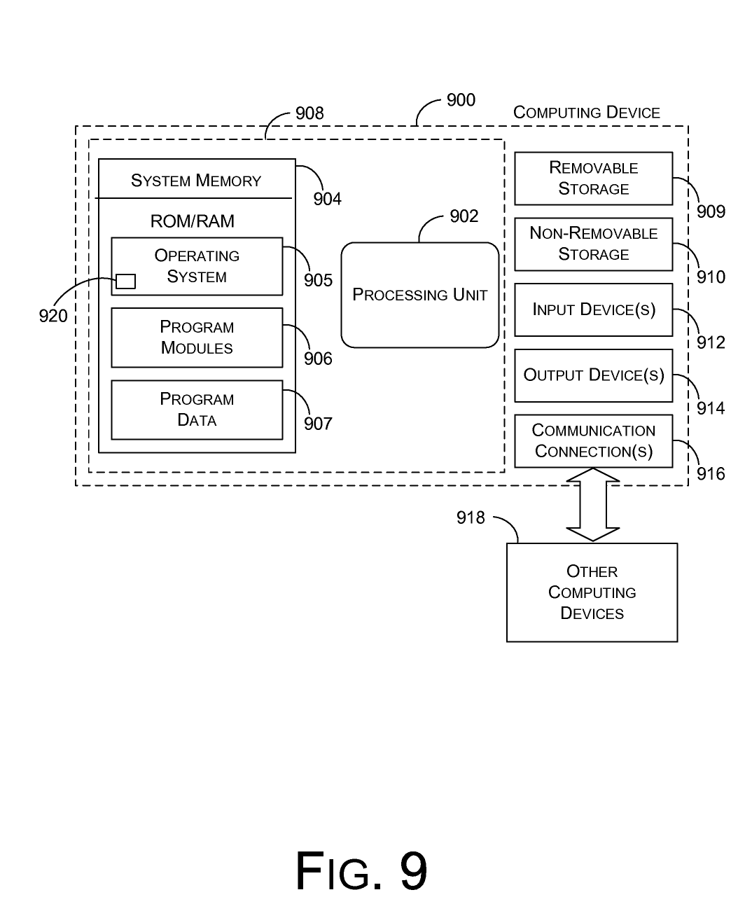

FIG. 9 illustrates an exemplary computing device 900 that may be used to implement various exemplary components and in forming an exemplary system. In a very basic configuration, computing device 900 typically includes at least one processing unit 902 and system memory 904. Depending on the exact configuration and type of computing device, system memory 904 may be volatile (such as RAM), non-volatile (such as ROM, flash memory, etc.) or some combination of the two. System memory 904 typically includes an operating system 905, one or more program modules 906, and may include program data 907. The operating system 905 include a component-based framework 920 that supports components (including properties and events), objects, inheritance, polymorphism, reflection, and provides an object-oriented component-based application programming interface (API), such as that of the .NET™ Framework marketed by Microsoft Corporation, Redmond, Wash. The device 900 is of a very basic configuration demarcated by a dashed line 908. Again, a terminal may have fewer components but will interact with a computing device that may have such a basic configuration.

Computing device 900 may have additional features or functionality. For example, computing device 900 may also include additional data storage devices (removable and/or non-removable) such as, for example, magnetic disks, optical disks, or tape. Such additional storage is illustrated in FIG. 9 by removable storage 909 and non-removable storage 910. Computer storage media may include volatile and nonvolatile, removable and non-removable media implemented in any method or technology for storage of information, such as computer readable instructions, data structures, program modules, or other data. System memory 904, removable storage 909 and non-removable storage 910 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 900. Any such computer storage media may be part of device 900. Computing device 900 may also have input device(s) 912 such as keyboard, mouse, pen, voice input device, touch input device, etc. Output device(s) 914 such as a display, speakers, printer, etc. may also be included. These devices are well known in the art and need not be discussed at length here. An output device 814 may be a graphics card or graphical processing unit (GPU). In an alternative arrangement, the processing unit 902 may include an “on-board” GPU. In general, a GPU can be used in a relatively independent manner to a computing device's CPU. For example, a CPU may execute a mixed reality application where rendering of mixed reality scenes occurs at least in part via a GPU. Examples of GPUs include but are not limited to the Radeon® HD 3000 series and Radeon® HD 4000 series from ATI (AMD, Inc., Sunnyvale, Calif.) and the Chrome 430/440GT GPUs from S3 Graphics Co., Ltd. (Freemont, Calif.).

Computing device 900 may also contain communication connections 916 that allow the device to communicate with other computing devices 918, such as over a network. Communication connections 916 are one example of communication media. Communication media may typically be embodied by computer readable instructions, data structures, program modules, or other data forms. By way of example, and not limitation, communication media includes wired media such as a wired network or direct-wired connection, and wireless media such as acoustic, RF, infrared and other wireless media.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An application, executable on a computing device, the application comprising:
a mapping module configured to access real image data of a three-dimensional space as acquired by a camera and to generate a three-dimensional map based at least in part on the accessed real image data;
a data module configured to access stored geometrically located data that represent one or more virtual items with respect to a three-dimensional coordinate system; and
a rendering module configured to render graphically the one or more virtual items of the geometrically located data, with respect to the three-dimensional map, along with real image data acquired by the camera of the three-dimensional space to thereby provide for a displayable mixed reality scene.

2. The application of claim 1 further comprising a tracking module configured to track field of view of the camera in real-time to thereby provide for three-dimensional navigation of the displayable mixed reality scene.

3. The application of claim 1 further comprising a screen capture module configured to capture a displayed screen for subsequent rendering in a mixed reality scene to thereby avoid a feedback loop between a camera and a screen.

4. The application of claim 1 further comprising an insertion module configured to insert and geometrically locate one or more virtual items in a mixed reality scene.

5. The application of claim 1 further comprising an edit module configured to edit or relocate one or more virtual items in a mixed reality scene.

6. The application of claim 1 further comprising a command module configured to receive commands from one or more input devices to thereby control operation of the application.

7. The application of claim 6 wherein the one or more input devices comprise at least one member selected from a group consisting of a keyboard, a camera, a microphone, a mouse, a trackball and a touch screen.

8. The application of claim 1 wherein the mapping module is configured to access real image data of a three-dimensional space as acquired by a camera selected from a group consisting of a webcam, a mobile phone camera, and a head-mounted camera.

9. The application of claim 1 wherein the mapping module is configured to access real image data of a three-dimensional space as acquired by a stereo camera.

10. The application of claim 1 further comprising a geography module configured to geographically locate the three-dimensional space.

11. The application of claim 1 wherein the data module is configured to access, via a network, geometrically located data stored a remote site.

12. A system comprising:
a camera with a changeable field of view;
a display; and
a computing device that comprises at least one processor, memory, an input for the camera, an output for the display and control logic to generate a three-dimensional map based on real image data of a three-dimensional space acquired by the camera via the input, to locate one or more virtual items with respect to the three-dimensional map, to render a mixed reality scene to the display via the output wherein the mixed reality scene comprises the one or more virtual items along with real image data of the three-dimensional space acquired by the camera and to re-render the mixed reality scene to the display via the output upon a change in the field of view of the camera.

13. The system of claim 12 wherein the camera comprises a field of view changeable by manual movement of the camera, by head movement of the camera or by sensing movement wherein the sensing comprises at least one member selected from a group consisting of sensing by computing optical flow, sensing by using one or more gyroscopes mounted on the camera, and by using position sensors that compute the relative position of the camera and the front of view of the camera.

14. The system of claim 12 wherein the camera comprises a field of view changeable by zooming.

15. The system of claim 12 further comprising control logic to store, as geometrically located data, data representing one or more virtual items located with respect to a three-dimensional coordinate system.

16. The system of claim 12 comprising a mobile computing device that comprises a built in camera and a built in display.

17. A method, implemented at least in part by a computing device, the method comprising:
accessing geometrically located data that represent one or more virtual items with respect to a three-dimensional coordinate system;
generating a three-dimensional map based at least in part on real image data of a three-dimensional space as acquired by a camera;
rendering to a physical display a mixed reality scene that comprises the one or more virtual items at respective three-dimensional positions in a real image of the three-dimensional space acquired by the camera; and
re-rendering to the physical display the mixed reality scene upon a change in the field of view of the camera.

18. The method of claim 17 further comprising issuing a command to target one of the one or more virtual items in the mixed reality scene.

19. The method of claim 17 further comprising locating another virtual item in the mixed reality scene and storing data representing the virtual item with respect to a location in a three-dimensional coordinate system.

20. One or more processor-readable media comprising processor executable-instructions for performing the method of claim 17.
